(19) United States
(12) Patent Application Publication
(10) Pub. No.: US 2014/0079851 A1
(43) Pub. Date: Mar. 20, 2014

(54) Egg Yolk Separator

(71) Applicant: Paul Osterberg, Austin, TX (US)

(72) Inventor: Paul Osterberg, Austin, TX (US)

(21) Appl. No.: 13/843,934

(22) Filed: Mar. 15, 2013

Related U.S. Application Data
(60) Provisional application No. 61/701,791, filed on Sep. 17, 2012.

(51) Int. Cl. A47J 43/14

(52) U.S. Cl. CPC A47J 43/14
USPC 426/298; 99/499

(57) ABSTRACT

A device and method are provided for separating an egg yolk from an egg white. The device is a handheld device which utilizes an elastic top dome connected to a rigid bottom funnel. The top dome is hermetically sealed to the bottom funnel. A user compresses the top dome to create an internal vacuum in the device which is utilized to draw an egg yolk into the device and away from the egg white. A user may then compress the top dome to evacuate the egg yolk from the device.

### PRIORITY OF THE INVENTION

This non-provisional application claims the benefit of priority under 35 U.S.C. §119(e) to U.S. Provisional Patent Application Ser. No. 61/701,791 entitled, “Egg Yolk Separator”, filed on Sep. 17, 2012, which is hereby incorporated by reference.

### TECHNICAL FIELD

This application related generally tools for cooking and food preparation, and more particularly, to a device and method for separating an egg.

### BACKGROUND OF THE INVENTION

Eggs are eaten all over the world. Eggs can be cooked by themselves or included as a part of other dishes. Eggs are comprised of the egg yolk and the egg white. Cooks sometimes desire to separate the egg yolk and the egg white for a variety of reasons. People who wish to eat eggs but want fewer calories, or need to limit cholesterol, will eat only the white portion of the egg. Also, some dishes or deserts only require the whites of the eggs to be used.

Separating the egg yolk from the egg white can be a difficult process. Cooks will use the egg shells to separate the egg by cracking the egg and attempting to retain the yolk within one of the two halves of the egg shell. There are problems with this method in that the shell may not break evenly, or the yolk may break and drip into the egg white. For this reason many cooks use egg separators to separate the egg yolk from the egg white. Egg separators are passive devices. Most are similar in shape to spoons and have slots. A cook will crack the egg and place it in the separator. The separator holds the egg yolk while the egg white drips into a bowl or a pan. This method is slow and inefficient in that it is purely reliant on the power of gravity for the separation of the egg yolk and the egg white. For this reason most egg separators are slow to use. What is needed is an active method for separating the egg yolk from the egg white.

### SUMMARY OF THE INVENTION

It is an object of the invention to provide an egg separator that is an active device which can be used quickly. The invention is an improvement over the prior art in that it provides an active method of separating the egg yolk from the egg white. In addition, one egg yolk may be picked up and deposited by the device numerous times. The device works smoothly without breaking the egg yolk. In addition, a user may crack numerous eggs into one receptacle and remove multiple egg yolks in one instance of use.

The invention is a device for separating an egg yolk from the egg albumen. The egg separator is comprised of a top dome formed of an elastic material and a bottom funnel composed of a rigid thermoplastic material. The bottom funnel has two open ends. The top open end has a larger diameter than the bottom open end. The volume of the bottom funnel is sufficient to hold at least one egg yolk. In one embodiment of the invention, the bottom edge of the top dome attaches to the larger diameter top open end of the bottom funnel to create a hermetic seal. The top dome may be sealed to the bottom funnel such that the top dome is permanently affixed to the bottom funnel. In another embodiment the top dome is thicker at the open end, forming a rib around the external circumference of the open end of the top dome. The bottom funnel has an indentation on the outer surface that extends around the circumference of the large diameter open end of the bottom funnel. The indentation is of a sufficient shape to receive the rib of the top dome.

In another embodiment, the bottom funnel may also have an external protrusion extending from the bottom funnel. The external protrusion extends around the circumference of the bottom funnel. The external protrusion is immediately below the indentation.

In another embodiment, the bottom funnel may have a spout protruding from the body of the bottom funnel. The spout is preferably substantially equal in circumference as the small diameter second open end of the bottom funnel. In other embodiments the spout may be of varying shapes and lengths. The spout may contain curvatures and bends so that the spout angles away from the body of the bottom funnel.

In any embodiments the top dome can be made of any elastic type material such as rubber or a thermoplastic elastomer.

In any of the embodiments the bottom funnel can be made of any type of rigid material including plastic, glass, or porcelain. Preferably the bottom funnel is formed of a thermoplastic material.

In another embodiment of the invention the device is comprised of a top dome, a bottom funnel, and a central ring. The top dome is hermetically sealed to the external surface of the central ring. The internal surface of the central ring has internal threading. The large diameter open end of the bottom funnel has external threading that is complementary to the internal threading of the central ring. The threading allows the central ring to be screwed onto the bottom funnel.

The invention is a method for separating an egg yolk from an egg white. The method comprises using a device with an elastic top dome and a rigid bottom funnel which are hermetically sealed together. A user compresses the elastic top dome. A user places the bottom funnel over an egg yolk. The user decompresses the elastic top dome, allowing the top dome to return to its original state and shape. The decompression creates an internal negative air pressure. The internal negative air pressure draws the egg yolk into the bottom funnel. The user then compresses the top dome which creates an internal positive air pressure. The internal positive air pressure evacuates the egg yolk from the bottom funnel. The method can be performed by any of the embodiments of the device.

### BRIEF DESCRIPTION OF THE DRAWINGS

FIG. 1 shows a perspective view of the invention.

FIG. 2 shows an exploded view of the invention.

FIG. 3 shows a perspective view of another embodiment of the invention

FIG. 4 shows a perspective view of another embodiment of the invention

### DETAILED DESCRIPTION

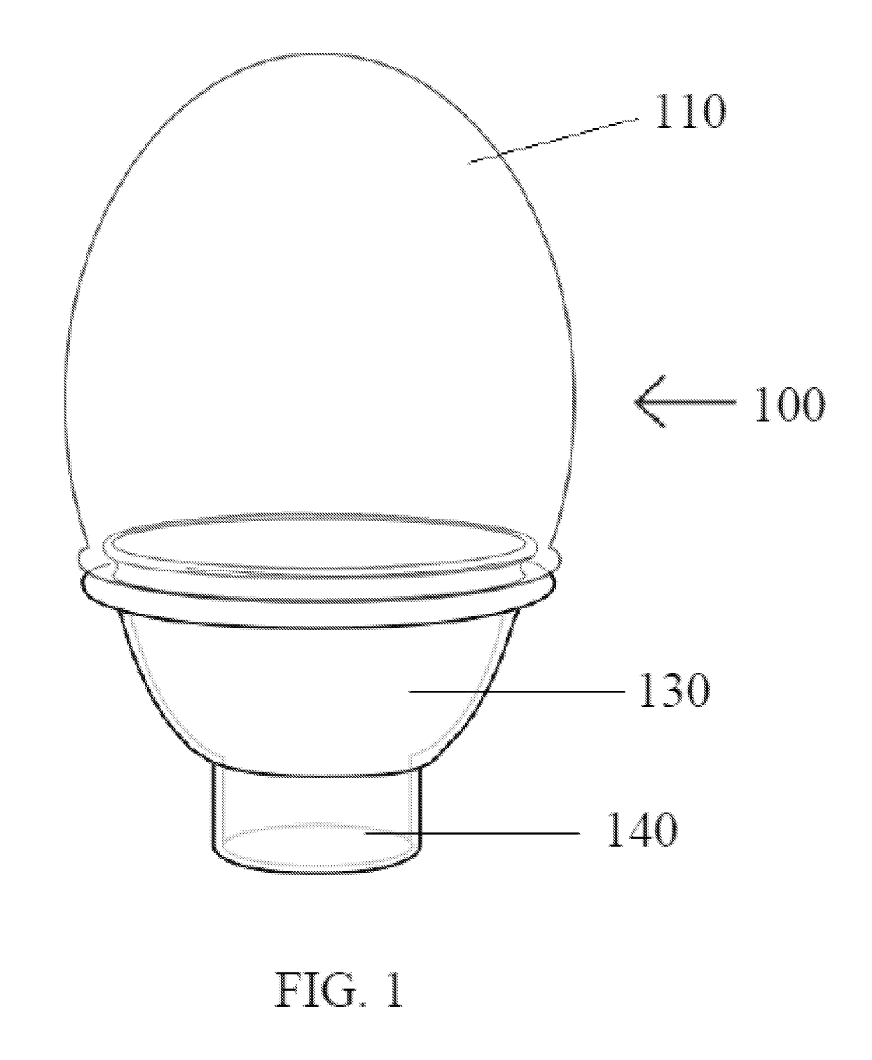

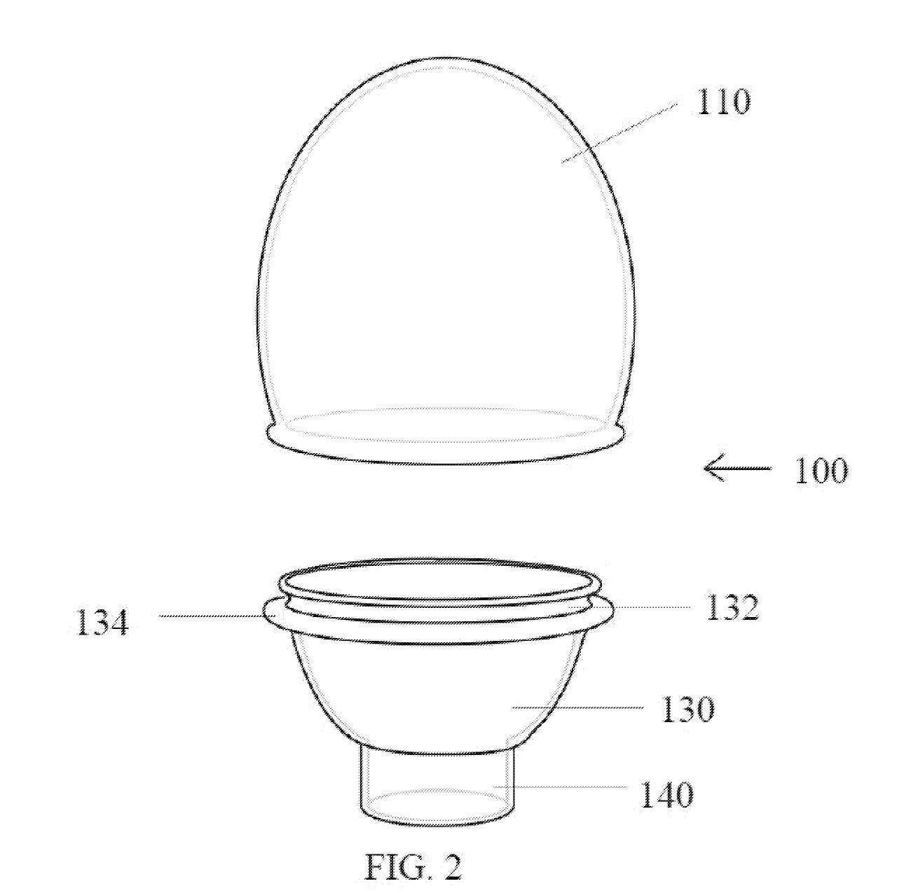

FIGS. 1-2 display the preferred embodiment of the invention. In this embodiment, the invention 100 is comprised of a top dome 110 and a bottom funnel 130. The tope dome 110 is manufactured out of a soft, elastic material. The top dome 110 can be compressed and distorted but will return to its original shape. The lower edge of the top dome 110 has a slightly thicker rib portion 115. The top dome 110 may be of any size and shape.

The diameter of the bottom funnel 130 narrows to a narrow spout 140 at the bottom edge of the bottom funnel 130. The spout 140 protrudes down from the body of the bottom funnel 130. The top edge of the bottom funnel 130 has a circular indent 132 around the outer circumference of the bottom funnel 130. Just below the indent 132, the bottom funnel 130 has a circular ridge 134 around the outer circumference of the bottom funnel 130. The indent 132 is shaped to receive the rib 115 of the top dome 110. The rib 115 fits within the indent 132 sufficiently to create an airtight seal around the circumference of the rib 115. When the rib 115 is fitted to the indent 132, the tension between the rib 115 and the indent 132 is sufficient so that the top dome 110 cannot be removed easily from the bottom funnel 130.

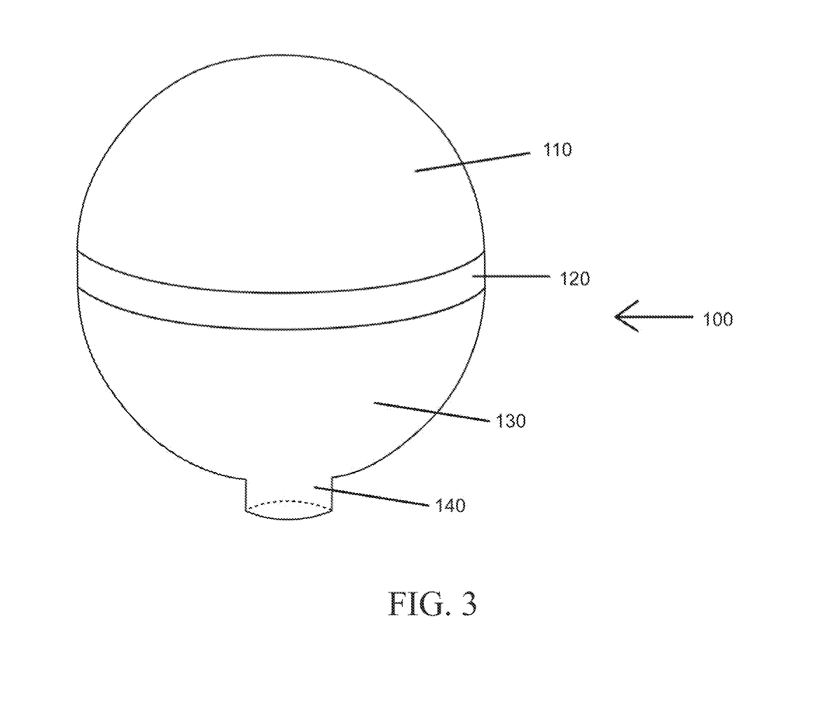

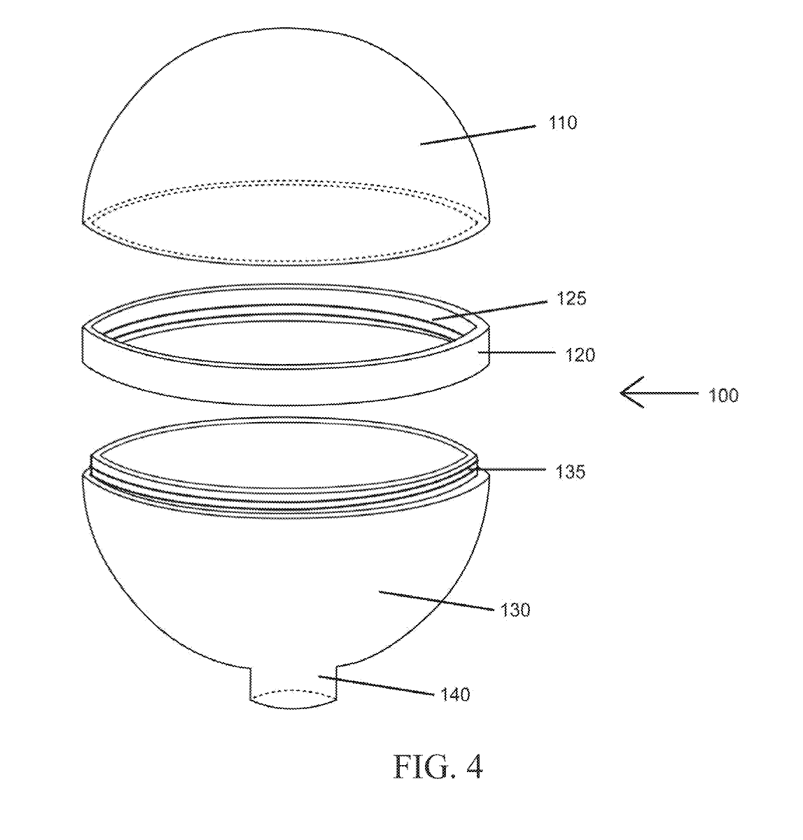

FIGS. 3-4 display another embodiment of the invention. In this embodiment the invention 100 is comprised of a top dome 110, a bottom funnel 130, and a center ring 120. The top dome 110 is manufactured out of a soft, elastic material. The top dome 110 can be compressed and distorted but will return to its original shape. The center ring 120 is manufactured out of a rigid material, preferably a thermoplastic. The bottom funnel 130 is manufactured out of a rigid material, preferably a thermoplastic. The bottom funnel 130 has threading 135 at the top edge. The top edge threading 135 is complimentary to the center ring threading 125. The bottom funnel 130 narrows from top edge threading 135 to a narrow spout 140 at the bottom edge of the bottom funnel 130. The bottom edge of the bottom funnel 130 is smaller in circumference than the upper edge 135 of the bottom funnel 130. The spout 140 protrudes down from the body of the bottom funnel 130.

The top edge threading 135 is placed on the outer surface of the bottom funnel 130. The center ring threading 125 is placed on the inner surface of the center ring 120. The top dome 110 is adhered to the outer surface of the center ring 120. The top dome 110 can be adhered to the center ring 120 by any number of means to create a hermetic seal. The center ring threading 125 allows the center ring 120 to be screwed together to the bottom funnel 130 via the top edge threading 135.

When the device 100 is fully put together, it can fit comfortably in one hand of the user.

In other embodiments of the invention, the spout 140 can be a variety of length and shapes, such as a neck. In other embodiments of the invention, the top dome 110 may be apparent in a variety of shapes, such as a separate bulb.

In one embodiment the center ring 120 and bottom funnel 130 do not have any threading. In this embodiment the center ring and bottom funnel snap together.

In one embodiment the top dome 110 is directly attached to the bottom funnel 130. In this embodiment the center ring 120 is not used. Also, in this embodiment, the bottom funnel 130 does not contain any top edge threading 135. The top edge threading 135 and the capability to separate the top dome 110 from the bottom funnel 130 does not affect the function of the device 100 but is only to increase the ease of cleaning the device 100.

To operate the device 100, a user cracks an egg and places the egg on a plate, bowl, or pan. The user depresses the top dome 110 a sufficient distance to create the potential for an internal vacuum in the device 100. The user then places the spout 140 over the egg yolk. The user ensures that the spout 140 contacts the egg yolk, thus creating a seal around the bottom edge of the bottom funnel. The user then releases top dome 110, creating a vacuum in the device 100. While the top dome 110 returns to its original shape, the vacuum created draws the egg yolk into the funnel 140 until the egg yolk is sufficiently drawn into the bottom funnel 130 and the vacuum is released. To dispense the egg yolk, a user can place the spout 140 over a container and depress the top dome 110. While in the bottom funnel 130 the egg yolk covers the spout 140. When the user depresses the top dome 110, positive air pressure builds behind the egg yolk, thus pushing the egg yolk out of the bottom funnel 130 through the spout 140.

1. A device for separating an egg yolk from the egg albumen comprising
A top dome wherein said top dome is formed of an elastic material
A bottom funnel, wherein the bottom funnel has a large diameter first open end and a small diameter second open end, the bottom funnel having a volume sufficient to hold an egg yolk

2. The device as in claim 1 wherein the top dome attaches to the bottom funnel to create a hermetic seal

3. The device as in claim 2 wherein the top dome is thicker at the open end forming a rib around the external circumference of the open end

4. The device as in claim 3 wherein the bottom funnel has an indentation on the outer surface said indentation extending around the circumference of the large diameter open end of the bottom funnel and said indentation sufficient to receive the rib of the top dome

5. The device as in claim 4 wherein the bottom funnel has an external protrusion extending from the bottom funnel said external protrusion extending around the circumference of the bottom funnel said external protrusion place immediately beside the indentation.

6. The device as in claim 5 wherein the bottom funnel has a spout protrusion extending from the body of the bottom funnel, said spout substantially equal in circumference as said small diameter second open end.

7. The device as in claim 6 wherein the top dome is made from thermoplastic elastomer

8. The device as in claim 7 wherein the bottom funnel is formed of a thermoplastic material.

9. The device as in claim 1 wherein the large diameter open end of the bottom funnel has external threading and further comprising a central ring said central ring having internal threading complementary to said external threading of the bottom funnel

10. The device as in claim 9 wherein the open end of the top dome is hermetically sealed to the external surface of said central ring.

11. The device as in claim 10 wherein the bottom funnel has a spout protrusion extending from the body of the bottom funnel, said spout substantially equal in circumference as said small diameter second open end.

12. The device as in claim 11 wherein the top dome is made from thermoplastic elastomer

13. The device as in claim 12 wherein the bottom funnel is formed of a thermoplastic material.

14. A method for separating an egg yolk and an egg white comprising
Using a device comprising an elastic top dome and a rigid bottom funnel said elastic top dome and rigid bottom funnel hermetically sealed together
Compressing said elastic top dome
Placing said bottom funnel over an egg yolk
Decompressing said elastic top dome allowing said top dome to return to its original state said decompression creating an internal negative air pressure said internal negative air pressure drawing said egg yolk into said bottom funnel

15. The method as in claim 14 further comprising compressing said top dome said compression creating an internal positive air pressure said internal positive air pressure evacuating said egg yolk from said bottom funnel.

16. The method as in claim 15
wherein the bottom funnel has a large diameter first open end and a small diameter second open end, the bottom funnel having a volume sufficient to hold an egg yolk
wherein the top dome is thicker at the open end forming a rib around the external circumference of the open end
wherein the bottom funnel has an indentation on the outer surface said indentation extending around the circumference of the large diameter open end of the bottom funnel and said indentation sufficient to receive the rib of the top dome
wherein the bottom funnel has an external protrusion extending from the bottom funnel said external protrusion extending around the circumference of the bottom funnel said external protrusion place immediately beside the indentation.

17. The method as in claim 16
wherein the bottom funnel has a spout protrusion extending from the body of the bottom funnel, said spout substantially equal in circumference as said small diameter second open end.

18. The method as in claim 17 wherein said top dome is made from thermoplastic elastomer

19. The method as in claim 17 wherein said bottom funnel is formed of a thermoplastic material

20. The method as in claim 15
wherein the bottom funnel has a large diameter first open end and a small diameter second open end, the bottom funnel having a volume sufficient to hold an egg yolk
wherein the large diameter open end of the bottom funnel has external threading and further comprising a central ring said central ring having internal threading complementary to said external threading of the bottom funnel wherein the open end of the top dome is hermetically sealed to the external surface of said central ring.
